(19) United States
(12) Patent Application Publication
(10) Pub. No.: US 2006/0133093 A1
(43) Pub. Date: Jun. 22, 2006

(54) Computer peripheral device with emitting homogenized light

(75) Inventor: Zhen-Bang Chen, Taipei (TW)

Correspondence Address: BACON & THOMAS, PLLC, 625 SLATERS LANE, FOURTH FLOOR, ALEXANDRIA, VA, 22314, US

(73) Assignee: KYE SYSTEMS CORP., TAIPEI (TW)

(21) Appl. No.: 11/017,862

(22) Filed: Dec. 22, 2004

(51) Int. Cl. F21V 5/02

(52) U.S. Cl. 362/340

(57) ABSTRACT

A computer peripheral device includes a body, a first light source for projecting a light, and a solid homogenizing body. The homogenizing body receives the light, and causes the light to diverge. As a result, the peripheral device can emit a homogeneous light.

### FIELD OF THE INVENTION

The present invention relates to a computer peripheral device, and in particular to a peripheral device that emits a homogeneous or uniform light therefrom.

### DESCRIPTION OF THE PRIOR ART

Computer peripheral devices, including but not limited to a computer mouse, trackball, keyboard, wireless receiver, hub, card reader, or mainframe, are well developed in function due to the successive advances in electronic technology. As a result, there are limited opportunities for enhancing market appeal by improving function. Instead, manufacturers have begun to concentrate on providing an enchanting appearance so as to satisfy the customer.

Besides providing various shapes and colors of the peripheral housing, the appearance of the peripheral devices can be improved by projecting light from the inside of the housing to create a surprising variety of visional effects. The known prior art disclosed in U.S. Pat. No. 6,547,420 is a light emitting input device that utilizes a light emitting diode (LED) as a light source in the housing. However, the projected area is too narrow to light the whole housing evenly. Even if the number of LEDs is increased, the housing of the device still rudely shows light spots corresponding to the number of LEDs in the housing. In addition, the heat generated by the LEDs is of serious concern as it can damage the whole electronic device.

### SUMMARY OF THE INVENTION

It is accordingly an objective of the present invention to provide a peripheral device which emits a homogeneous or uniform light from the housing.

To accomplish the objective mentioned above, the peripheral device comprises a body having a circuit board inside, a first light source for projecting a light, and a solid homogenizing body. The homogenizing body receives the light such that the light diverges from a homogenizing surface of the homogenizing body. By the structure mentioned above, the peripheral device can emit a homogeneous light therefrom.

### BRIEF DESCRIPTION OF THE DRAWINGS

FIG. 1 is an exploded perspective view of the present invention.

FIG. 2 is a perspective view of the homogenizing body according to the present invention.

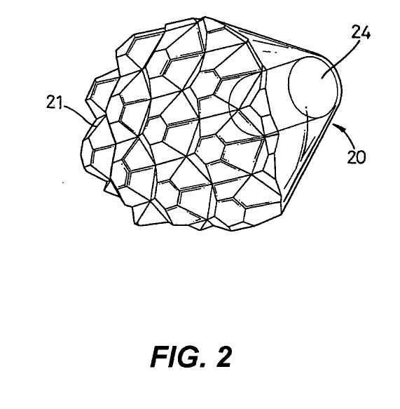

FIGS. 3˜5 are sectional views showing assembly of the homogenizing body within the body of a peripheral device.

FIG. 6 is another perspective view of the homogenizing body and the homogenizing portion of the body of the peripheral device.

### DETAILED DESCRIPTION OF THE PREFERRED EMBODIMENTS

The following detailed description is of the best presently contemplated modes of carrying out the invention. This description is not to be taken in a limiting sense, but is made merely for the purpose of illustrating general principles of embodiments of the invention. The scope of the invention is best defined by the appended claims. Therefore, the computer peripheral devices mentioned in the invention may include but are not limited to a computer mouse, trackball, keyboard, wireless receiver, hub, card reader, or particularly to a housing of a computer or the like.

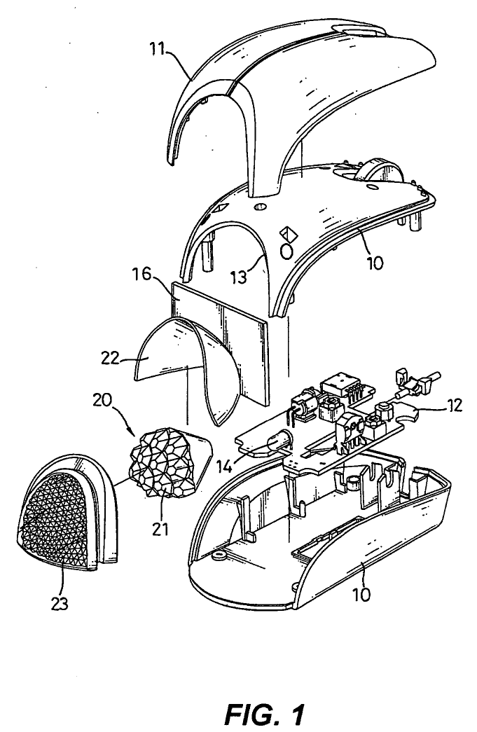

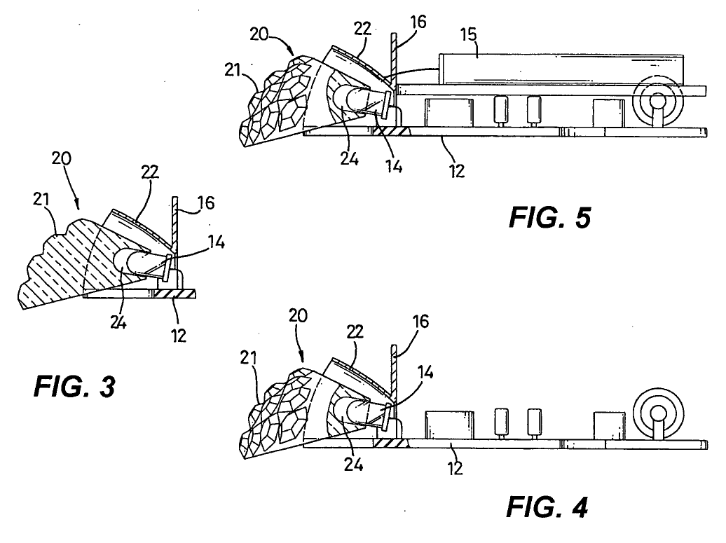

Referring to FIGS. 1˜2, the peripheral device, a computer mouse for example, has a body with a housing 10 and a button plate 11. A circuit board 12 is located within the housing 10 for furnishing the known functions of the peripheral device. A light source 14 coupled to the circuit board 12 can project a light to a light transmitting solid homogenizing body 20. The homogenizing body 20 may provide a recess 24 for completely receiving the light, and a homogenizing surface 21 with a plurality of protrusions thereon. The light is further diverged through the homogenizing surface 21 so as to emit a homogeneous light therefrom. Referring to FIGS. 1, 3, and 4, the homogenized body 20 is covered by a reflecting board 22, and hence the projected light of the light source 14 can be reflected, concentrated and conducted within the homogenizing body 20 for further divergence by the homogenizing surface 21. The homogenizing surface 21 can be a plurality of protrusions, in which case the light projected by the light source 14 can be scattered around the whole homogenizing surface 21. One skilled in the art will appreciate that the homogenizing surface 21 can be replaced by a rough surface to create an alternative homogeneous visual effect.

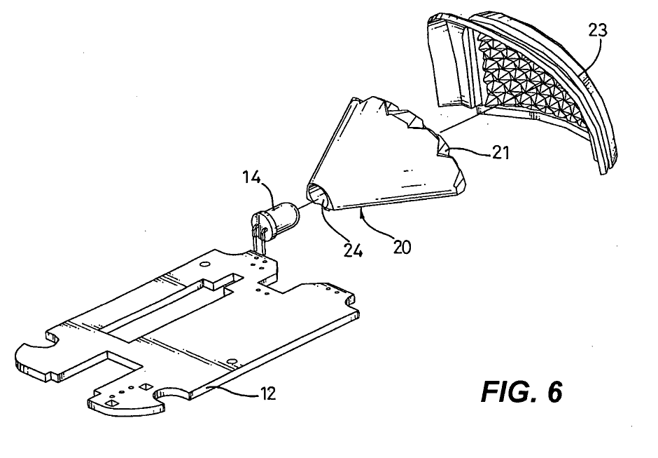

Referring to FIGS. 1 and 6, the body has a homogenizing portion 23 which corresponds to the homogenizing surface 21, and which is fitted within an opening 13 of the body. In order to emphasize the visual effect, the homogenizing portion 23 also has a plurality of protrusions similar to the homogenizing surface 21. In addition, it is also possible for the homogenizing portion 23 to include a rough surface to create an alternative homogeneous visual effect.

Referring to FIGS. 1, and 3-5, a shield 16 is positioned within the body. The shield 16 is located between the light source 14 and the light source 15. Therefore the two projected lights will not visually interfere with each other. Moreover, to enhance utilization of the light source 15, the housing 10 can be further modified by a method mentioned in U.S. Pat. No. 6,547,420 such that logos, trademarks, texts, figures can be interestingly formed on the housing 10. Therefore, once a light transmitting button plate 11 is placed on the housing 10, a unique illuminating visual effect will be seen simultaneously upon the button plate 11.

Alternatively, the light source 15 may project a light for detecting a coordinate position of the peripheral device relating to a computer system. This type of peripheral is well known as an “optical detecting system”, and may take the form of an optical mouse or optical track ball. In that case, the shield 16 has to be located between the two light sources as to prevent the light source 14 from interfering with operation of the optical detecting system.

The homogenizing body 20 can be any desired configuration or shape. Meanwhile, the protrusions of the homogenizing surface 21 or the homogenizing portion 23 are not limited to a hexagonal or diamond-like configuration, so long as the homogenizing surface 21 and/or homogenizing portion 23 diverges the light projected by the light source 14.

While the description above refers to particular embodiments of the present invention, it will be understood that many modifications may be made without departing from the spirit thereof. The accompanying claims are intended to cover such modifications as would fall within the true scope and spirit of the present invention.

What is claimed is:

1. A computer peripheral device having a body, the body comprising:
a circuit board for furnishing a function of the peripheral device;
a first light source for projecting a light; and
a solid homogenizing body arranged to transmit the light;
wherein the homogenizing body has a first end for receiving the light, and a second end provided with a homogenizing surface; and
wherein the light is diverged by the homogenizing body so as to cause the homogenizing body to emit homogeneous light.

2. The peripheral device as claim in claim 1, wherein the first end of the homogenizing body has a recess for receiving the light.

3. The peripheral device as claim in claim 1, wherein the homogenizing surface has a plurality of protrusions.

4. The peripheral device as claim in claim 1, wherein the homogenizing surface is a rough surface.

5. The peripheral device as claim in claim 1, wherein the homogenizing body is covered by a reflecting board.

6. The peripheral device as claim in claim 1, wherein the body has a homogenizing portion corresponding to the homogenizing surface.

7. The peripheral device as claim in claim 6, wherein the homogenizing portion has a plurality of protrusions.

8. The peripheral device as claim in claim 6, wherein the homogenizing portion is a rough surface.

9. The peripheral device as claim in claim 1, wherein the body has a shield within the body.

10. The peripheral device as claim in claim 9, wherein the shield is located between the first light source and a second light source.

11. The peripheral device as claim in claim 10, wherein the second light source projects a light for detecting a coordinate position.

12. The peripheral device as claim in claim 1, wherein the peripheral device is a housing of a computer system.
